(19) United States
(12) Patent Application Publication
(10) Pub. No.: US 2016/0116630 A1
(43) Pub. Date: Apr. 28, 2016

(54) SCALABLE CONFIGURATIONS FOR MULTIMODE PASSIVE DETECTION SYSTEM

(71) Applicant: Decision Sciences International Corporation, Poway, CA (US)

(72) Inventor: Michael James Sossong, Ramona, CA (US)

(21) Appl. No.: 14/918,393

(22) Filed: Oct. 20, 2015

Related U.S. Application Data
(60) Provisional application No. 62/066,837, filed on Oct. 21, 2014.

(51) Int. Cl. G01V 5/00; G01T 1/18

(52) U.S. Cl. CPC G01V 5/0075; G01T 1/18

(57) ABSTRACT

Techniques, systems and apparatus are described for a multimode passive detection system (MMPDS). A MMPDS includes a detector assembly of array of drift tubes arranged as detector modules to generate detector signal data representing electrical responses to cosmic ray charged particles passing through respective detector modules and traversing through a volume of interest (VOI). Detector circuitry measures the generated detector signal data and outputs the measured detector signal data as spatially segregated data streams corresponding to respective detector modules. A clock system distributes a master clock signal throughout the detector circuitry. A compute cluster including nodes of computing devices merges the spatially segregated data streams into temporally segregated data, obtains information on tracks of the cosmic ray charged particles based on the temporally segregated data, reconstructs an image of the volume of interest based on the obtained information, and identifies an object in the VOI based on the reconstructed image.

### CROSS REFERENCE TO RELATED APPLICATIONS

This patent document claims the benefit of priority of U.S. Provisional Patent Application No. 62/066,837, filed on Oct. 21, 2014. The entire content of the before-mentioned patent application is incorporated by reference as part of the disclosure of this document.

### BACKGROUND

This patent document relates to devices, techniques, storage media embodying computer program products and systems for tomographic imaging using ambient cosmic rays.

Tomographic imaging systems have been developed to rely on active sources of radiation with well-characterized illumination beams. Examples of active radiation source tomographic imaging systems include x-ray CT scanning systems.

Large particle detector arrays such as those used in high-energy particle research facilities (e.g., European Council for Nuclear Research (CERN) and the Fermi National Accelerator Laboratory (Fermilab)) have been designed to detect a specified range of particles, particle energies, or both for addressing a specific detection problem.

Effective inspection of the traffic at borders, airports and seaports is essential to protect the world from terrorist threats, including illegal transportation and use of nuclear materials. While the goal of the U.S. Government is to screen all traffic and cargo transported into the country, in reality only a small fraction of incoming cargo is physically inspected (5-6% in the U.S., much lower internationally).

### SUMMARY

Charged particles continuously rain down on the surface of the Earth. These charged particles primarily consist of muons and electrons. Muons are subatomic particles with the same charge as the electron, but with 200 times the mass. These particles are generated from interactions of primary cosmic-rays, primarily protons, with the upper atmosphere. Techniques, systems, storage media embodying computer program products and devices are described for implementing a tracking detector to measure the interactions of these particles with materials through which they pass: multiple Coulomb scattering and ionization energy loss as a result of these measurements is able to reconstruct a three-dimensional map of the density and atomic number of the materials in a scan volume. This map can be used to automatically detect bulk contraband (including explosives, narcotics and other materials) in the cargo as well as provide highlighting of anomalous configurations (nested or irregular volumes) for review by authorities. Fusion of the imaging with the sensitive gamma detection capability of the tracking detector enables the detection of nuclear and radiological materials that may be concealed in shielding, as well as discrimination of naturally occurring radioactive materials (NORM) from point sources that would be more associated with threats. Times to clear most non-threat cargo range from 30-60 seconds, with suspicious scenes (heavy shielding, gamma emitting materials or materials with similar signatures to contraband materials) being held longer to confirm the presence of and identify the material. Extended scanning of suspicious scenes typically takes two to ten minutes. The tracking detector can be implemented as a scanning system in various configurations depending on the location, application, or both of the scanning system. The potential configurations include a large scale container-handling scanner to accommodate on-pier scanning at a port for transshipped containers. A smaller version of this configuration could accommodate the scanning of air-cargo containers or crates in line with aircraft loading. Other potential configurations include a pallet and large package configuration to accommodate warehouse or loading-dock scanning of cargo.

In one aspect, a relocatable multimode passive detection system includes a platform structure sized to receive cargo containers to be scanned. The relocatable multimode passive detection system includes a support base to provide physical support for the platform. The support base includes adjustable members to compensate for a variation in terrain on which the support base in placed. The relocatable multimode passive detection system includes multimode passive detection-based scanner hardware including detector arrays of charge particle sensors and a scanner housing to house at least some of the hardware for the multimode passive detection-based scanner. The scanner housing is locating at a predetermined location between two ends of the platform structure to provide a scan volume sized to hold a cargo container to be scanned.

The relocatable multimode passive detection system can be implemented in various ways to include one or more of the following features. The detector arrays can include an upper detector array placed above the scan volume and a lower detector array placed below the scan volume to detect cosmic-ray particles entering and exiting the scan volume from above the scan volume. The detector arrays can include a pair of lateral detector arrays placed at two opposing sides of the scan volume to detect cosmic-ray particles entering and exiting the scan volume from either side of the scan volume. The support base can include a set of wheels for relocating the multimode passive detection system. The adjustable members can include hydraulic jacks. The components of the relocatable multimode passive detection system can be structured and sized to accommodate on-pier scanning at a port for scanning cargo containers. The components of the relocatable multimode passive detection system can be structured and sized to accommodate on-pier scanning at a port for scanning cargo containers. The components of the relocatable multimode passive detection system can be structured and sized to accommodate scanning of air-cargo containers or crates in line with aircraft loading. The platform structure can include rollers for moving the cargo container from one end to other end. The scan volume area can be provided by placing the scanner housing and at least some of the hardware to surround a portion of the platform in an outer ring-like or outer shell-like manner. The scanner housing can include a module frame positioned to surround or encompass a portion of the platform structure to form a rectangular-like shape. The charge particle sensors can include sealed drift tubes. The charge particle sensors can be structured to sense gamma rays. The relocatable multimode passive detection system can include stopper bars to protect the hardware from physical damage.

In another aspect, a relocatable multimode passive detection system includes a platform structure sized to receive pallets or large packages to be scanned. The relocatable multimode passive detection system includes a support base to provide physical support for the platform. The support base includes adjustable members to compensate for a variation in terrain on which the support base in placed. The relocatable multimode passive detection system includes multimode passive detection-based scanner hardware including detector arrays of charge particle sensors and a scanner housing to house at least some of the hardware for the multimode passive detection-based scanner. The scanner housing is located at a predetermined location between two ends of the platform structure to provide a scan volume sized to hold a cargo container to be scanned.

The relocatable multimode passive detection system can be implemented in various ways to include one or more of the following features. For example, the detector arrays can include an upper detector array placed above the scan volume and a lower detector array placed below the scan volume to detect cosmic-ray particles entering and exiting the scan volume from above the scan volume. The detector arrays can include a pair of lateral detector arrays placed at two opposing sides of the scan volume to detect cosmic-ray particles entering and exiting the scan volume from either side of the scan volume. The components of the relocatable multimode passive detection system can be structured and sized to accommodate scanning of the pallets or large containers at a warehouse. The components of the relocatable multimode passive detection system are structured and sized to accommodate scanning of the pallets or large containers at a loading-dock. The charge particle sensors can include sealed drift tubes. The charge particle sensors can be structured to sense gamma rays.

The system, device and techniques described in this document can be implemented as part of an inspection system to inspect volumes of interest for the presence of nuclear threats and other contraband or hazardous items, using ambient or controlled-source illuminating radiation. The described systems, devices and techniques can be used in inspection of cargo containers or crates at a port or aircraft loading area. Other potential embodiments can include, for example, inspection of packages, personnel, large containers, large packages, pallets, etc. at warehouses and loading-docks.

Cosmic-ray scanning is the only passive non-intrusive imaging solution. The MMPDS described in this patent document implements cosmic ray scanning for detection of nuclear and radiological materials in maritime cargo containers or crates and occupied vehicles. The described technology may have many other applications for enhancing nuclear security.

### BRIEF DESCRIPTION OF THE DRAWINGS

FIG. 1 is a schematic diagram of scattering or stopping of muons and electrons in different materials.

FIG. 2A is a diagram shown sealed drift tubes function by detecting ionization caused by the passage of charged particles through the gas volume.

FIG. 2B is a block diagram showing a multi-mode passive detection system (MMPDS) data flow.

FIG. 3A is a schematic diagram showing muons traversing a detector arrays and scattering in an object in a scan volume between the detector arrays.

FIG. 3B shows an exemplary MMPDS scanner with multiple detector arrays.

FIG. 4 is a schematic diagram showing scattering of a cosmic ray particle in an object.

FIG. 5 is a schematic diagram of scattering and stopping of tracks passing through objects in a scan volume between upper and lower detector arrays.

FIG. 6 is a reconstructed map of a scan volume showing high scattering regions in red.

FIG. 7 is a chart showing material discrimination based on measured cosmic ray parameters of scattering density and stopping power based on a ten minute scan of a number of materials including explosives, flammables, and explosive precursors.

FIG. 8 is a cosmic-ray scan image (3 minute exposure) of four pallets of office paper with glossy paper replacing the top layer on the left-most pallet.

FIG. 9 is a drawing showing an exemplary container-handling configuration design.

FIG. 10A is a drawing showing pallet and large package configuration design.

FIG. 10B is a diagram showing a view of an exemplary MMPDS Scanner in a pallet and large package configuration with external enclosure removed, exposing drift-tube sensor panels and the detector support frame.

FIG. 10C is a drawing showing an exemplary scene support bridge and conveyor structure associated with the pallet and large package configuration.

FIG. 11 is a data flow diagram showing an exemplary systems architecture for implementing a pallet and large package configuration using MMPDS.

Like reference symbols and designations in the various drawings indicate like elements.

### DETAILED DESCRIPTION

This patent document discloses technology for providing effective inspection of traffic at borders, airports and seaports. The disclosed technology includes a multi-mode passive detection system (MMPDS) that combines multiple passive detection modalities including cosmic-ray generated charged particle (“cosmic-ray particle”)-based tomography and passive gamma radiation detection adapted, developed and optimized for checkpoint screening. For example, an MMPDS implemented based on the disclosed technology can be scaled to fit various location dependent system configuration, application dependent system configuration, or both used to inspect cargo safely and efficiently. The cosmic ray particle based tomography modality in MMPDS uses naturally occurring cosmic ray particles to obtain an image of the scanned volume, is completely passive and involves no active or additional application of ionizing or other radiation for the inspection of cargo. Similarly, passive gamma radiation detection uses on additional application of ionizing or radiation other than the gamma radiation emitted by the fissile materials in the object under inspection. The combination of cosmic ray particle tomography and passive gamma radiation detection can enable non-intrusive inspection of cargo and vehicles for hidden radiological and nuclear threats.

While originally intended for nuclear detection, MMPDS can be used to discriminate materials ranging from low density contraband materials to high-density nuclear materials. Signatures can be extracted from a 3D map providing discrimination of materials much more powerful than is available from other technologies. For example, a primary scan can clearly discriminate pallets of standard office paper from glossy paper used in magazines. This provides for the automatic detection of contraband materials from a material library as well as highlighting of anomalous configurations of materials, such as materials obscured by benign materials or expected uniform loads with irregular contents. Suspicious configurations can be reviewed by an operator to determine consistency with the cargo manifest.

Cosmic-Ray Generated Charged Particles

The earth is constantly bombarded by high-energy cosmic rays originating from astrophysical sources. Primary cosmic rays include mostly of hydrogen nuclei (protons) and helium nuclei (alpha particles). These primary cosmic rays interact with earth's atmosphere to produce secondary cosmic rays that are primarily pions with very short lifetimes (˜30 ns). Charged pions decay into weakly interacting muons with long lifetimes that arrive at the surface of the earth. Neutral pions decay into gamma rays that can interact with air molecules to produce electrons. While muons and electrons have the same magnitude of charge, muons are about 200 times more massive than electrons and therefore scatter less due to their higher momenta. The reduced scattering due to the massive size enables the muons to pass through most materials with very little scattering. This scattering property of muons makes muons an effective probe for high density and high atomic number materials such as special nuclear materials (SNM) as well as dense materials typically used to shield gamma radiation. Electrons, on the other hand, are a more effective probe for differentiating lower density and lower atomic number materials due to their higher scattering and absorption in these materials.

Muons travel at relativistic speeds, are highly penetrating and can travel an average of about 20,000 m in their 60 is mean relativistically time-dilated lifetime at their mean momentum. The muons do not arrive at the earth's surface like vertical rain, but rather with a cosine-squared angular dependence which has an average incident angle of about 37.5 degrees. The average muon energy at sea level is 3 GeV and the flux is about 10,000/m²/min, which increases with altitude. Cosmic ray electrons (and positrons) have typical energies from 0.01-1 GeV and have a sea level incident flux of about 5120/m²/min.

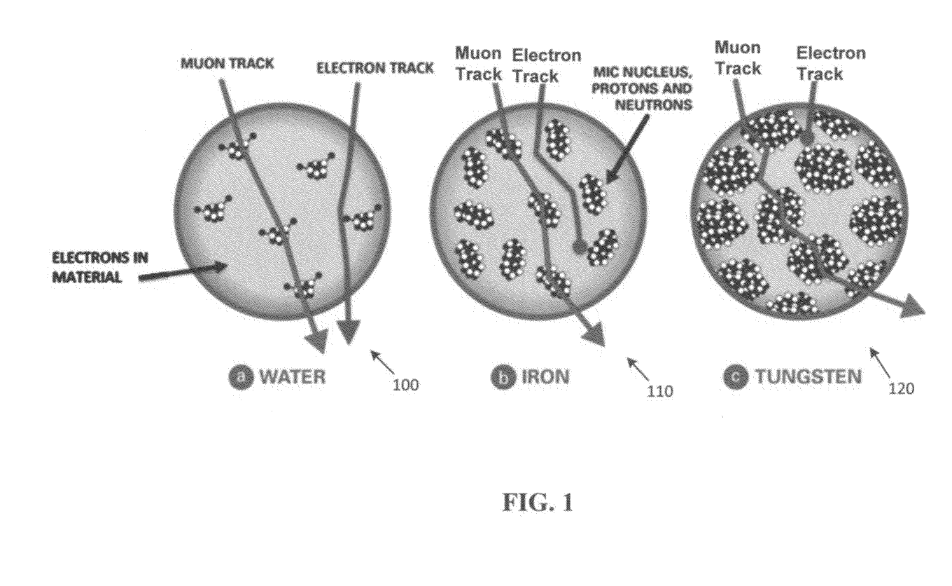

FIG. 1 is a schematic diagram of the scattering, stopping, or both of muons and electrons in different materials. Particle scattering and stopping increases as the density and the atomic number of the material increases. In the example shown in FIG. 1, muon and electron scattering increases as the density and atomic number increase from (a) water 100 to (b) iron 110 to (c) tungsten 120.

Charged Particle Signals

As the charged muons and electrons pass near a nucleus, charged muons and electrons are subject to Coulomb scattering. The charge on the nucleus (proportional to the atomic number) and the frequency of the scattering (depends on the material density) determines the width of the distribution of the scattering. The scattering width increases with higher density and atomic number. Additionally, the charged particles lose energy to the electrons of the material through which the charged particles pass. This energy loss increases approximately with the density of the material. By measuring the spatial distribution of the charged particle scattering and attenuation within a volume, a tomographic map of signatures related to the density and atomic number of the materials that fill the volume can be obtained. This tomographic map enables the detection and spatial location of threat or contraband materials by comparison with a material library. High density and high atomic number materials (including SNM) produce very strong scattering and attenuation signal. Increasing the thickness of shielding materials around SNM or other radioactive materials can improve the detection system's (e.g., MMPDS) ability to detect these threats using muon tomography due to the increased scattering caused by the thicker shielding. Hence, muon tomography combined with passive radiation detection is a powerful technique to detect SNM and other nuclear and radiological threats. Lower density or atomic-number materials have weaker signals and more overlapping signatures, requiring more particles to provide discrimination. Because the particle flux is limited and discrimination depends on the number of particles through the material, detectable material quantities are larger for low-density materials for a fixed scan time. Interesting and threatening quantities of low-density materials are much larger, providing useful detection with scan times under two minutes, for example. A considerable advantage of the method is that it is completely passive and relies solely on naturally-occurring incident particles rather than applied ionizing radiation.

MMPDS Hardware

MMPDS can be implemented as various scanners of different configurations to use muon tomography for the detection of concealed SNM. In addition to muon tomography, the scanners in different configurations can use passive gamma detection to detect concealed radioactive objects. The different configurations for the MMPDS-based scanners can include large scale systems and smaller systems depending on the application and location implemented. The large scale systems can scan full-size trucks and shipping containers for concealed SNM materials.

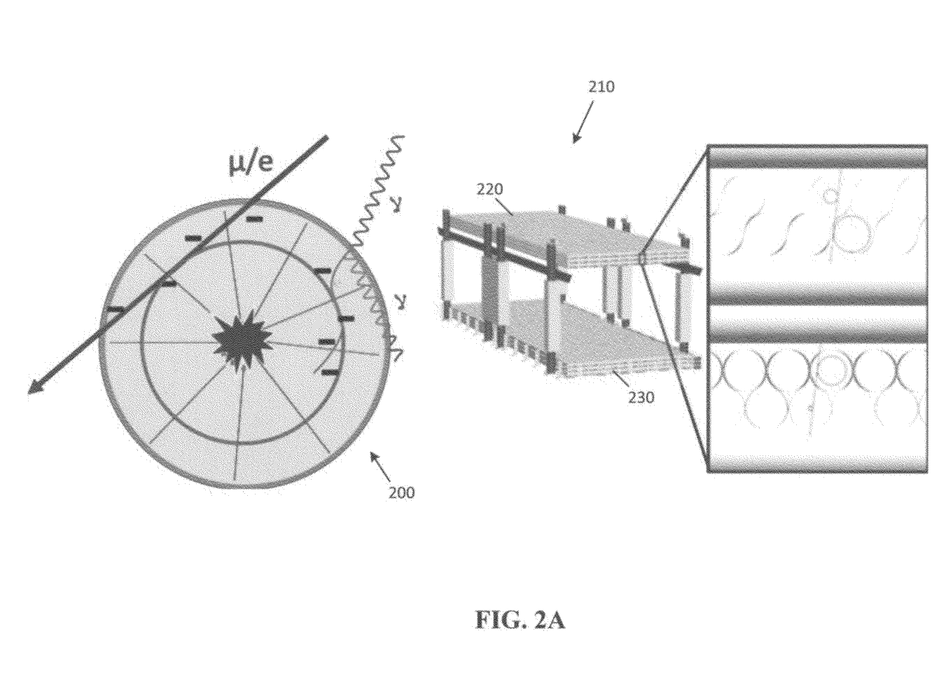

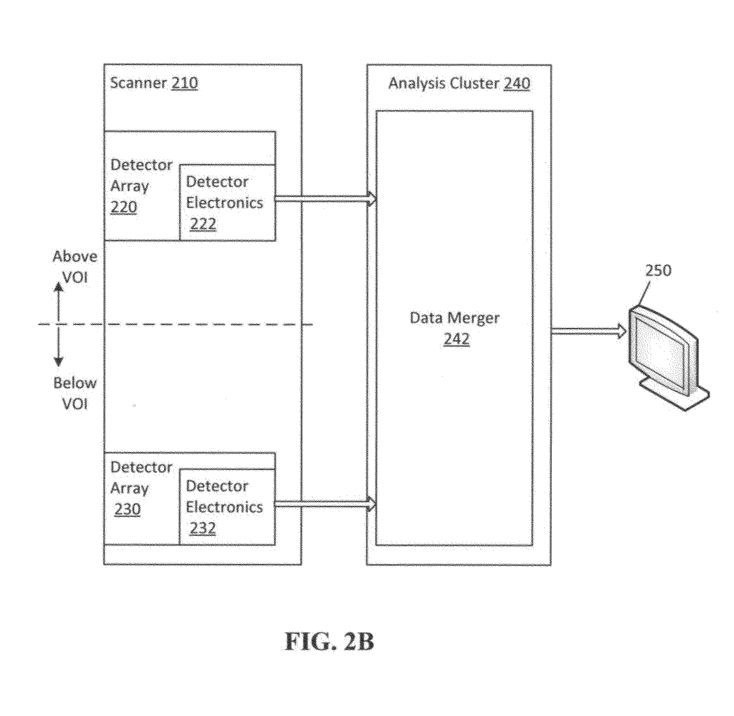

In MMPDS, an array of sealed drift tubes is used as the primary sensor element in the scanner. FIG. 2A shows a cross-section view of an exemplary drift tube 200 on the left and on the right, an exemplary scanner 210 with drift tube detector arrays 220 and 230 located above and below a volume to be scanned respectively. A drift tube is an ionization detector that produces electrical signals in response to ionizing particles or radiation that pass into or through its volume. Sealed drift tubes are very robust, durable sensors requiring no maintenance over many years. Each tube can provide high-precision position measurement of a traversing charged particle over a large area while requiring only one signal processing channel. Using timing information of the arrival time of the ionized electrons, a radius can be calculated. This provides a sub-millimeter position resolution measurement of the path of the charged particle. The three-dimensional trajectory of the particle is reconstructed from measurements in several layers of tubes such as the ones shown in the exemplary scanner on the right side of FIG. 2A.

In one implementation, the drift tube is a sealed, gas-filled cylinder having conducting walls (cathode) and a fine wire element strung longitudinally down the tube (anode). A high voltage is applied between the anode and the cathode. The gas sealed in the drift tube mixture is ionized by the passage of muons or electrons which results in a number of electron-ion pairs (on the order of 25 pairs per 1 cm path of a muon). The drift-tubes in the scanner can also detect gamma rays. The incidence of gamma rays on the aluminum walls causes Compton electrons to be emitted from the conductive wall of the tube, causing ionization of the drift tube gas. Thus, the ability of the sealed drift tubes to detect gamma rays provides a second modality to detect contraband including special nuclear materials.

FIG. 2B is a block diagram showing data flow from detector arrays to analysis cluster through custom electronics. The drift tube electrical signals are detected, amplified and identified by first stage electronics. The temporal information of the electrical signal from the drift tubes in the detector arrays 220 and 230 can be used to determine the closest approach radius between the charged particle path and the wire. Custom electronics 222 and 232, installed at one end of the drift tubes, acquire, time stamp and filter drift tube signals. Data is delivered to analysis cluster 240 running software to identify muon and gamma events, calculate tracks and perform tomographic reconstruction that produces a three-dimensional map of the materials of the volume under inspection. This data is analyzed to produce a map of the position and distribution of radioactive sources within the volume. An operator working at a workstation (e.g., 250) can access, view and process the data from the analysis cluster 240.

Detector array 220 and 230 can be made up of modules of drift tubes, and each module in a detector array can be communicatively linked to corresponding custom electronics 222 and 232 to transmit electrical signals from individual modules to the analysis cluster 240. A separate custom electronics can be associated with each module or one or more custom electronics can communicate with multiple modules. Individual electrical signals from the custom electronics 222 and 232, which are spatially segmented, can be processed and merged into time sliced data by a data merger 242 in the analysis cluster 240.

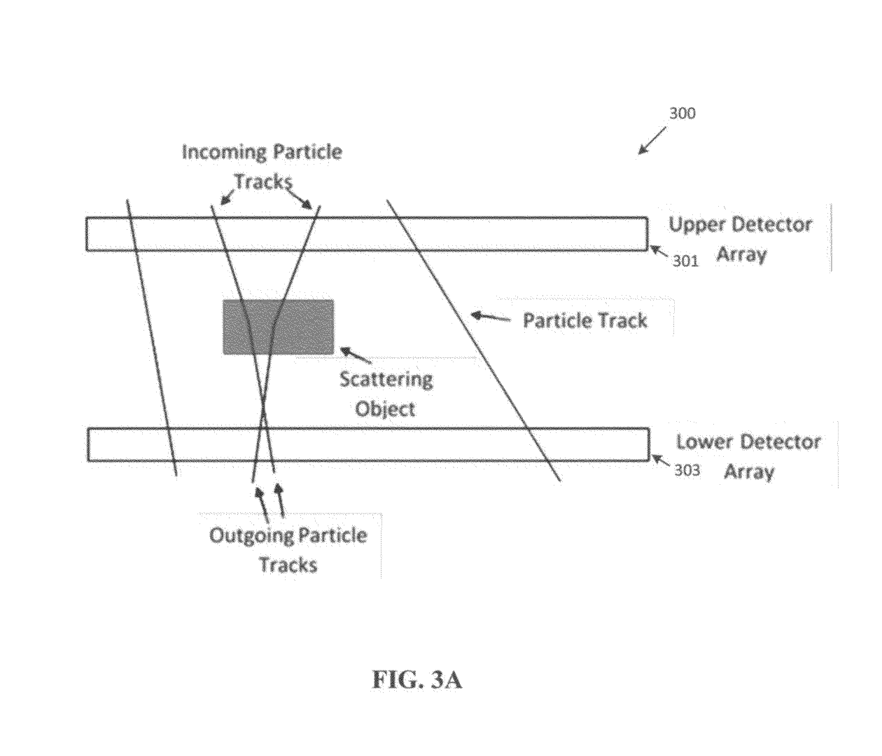

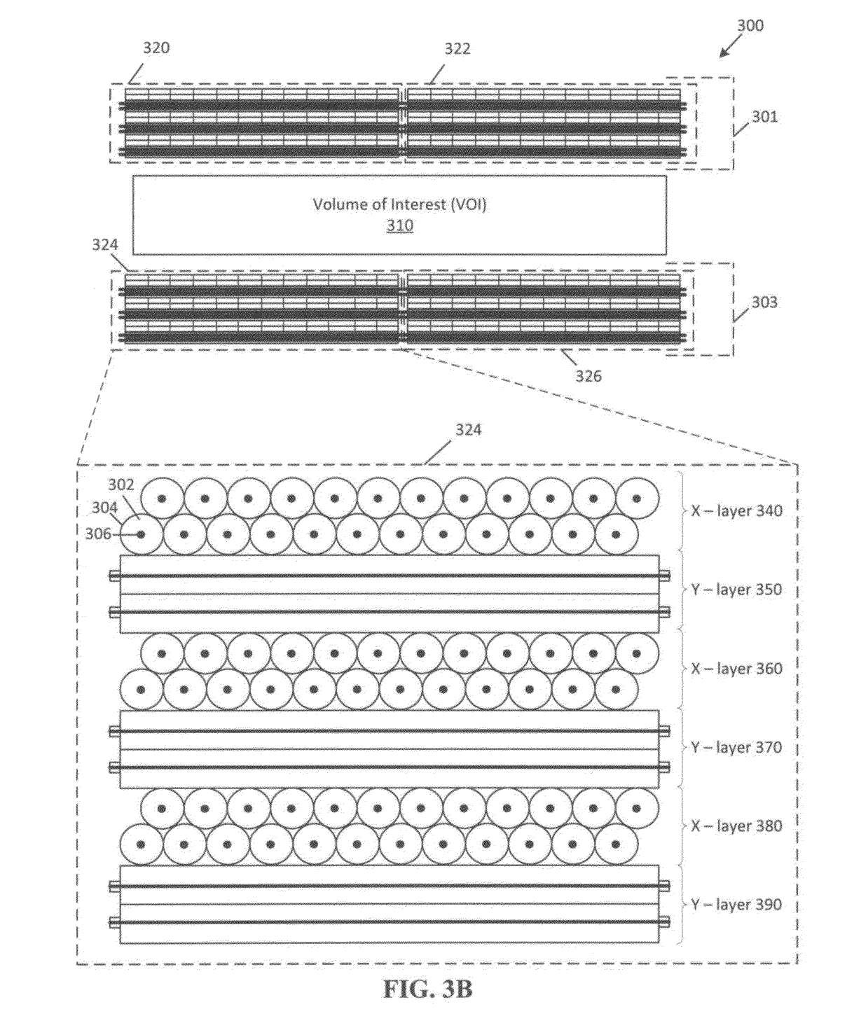

FIG. 3A is a schematic diagram showing muons traversing sealed drift tube detector arrays of a scanner 300 and scattering in an object in the scan volume between the upper and lower detector arrays. The scattering angle is greatly exaggerated in this figure; the actual angle is a few milliradians. The exemplary scanners shown in FIG. 3A and on the right side of FIG. 2A are constructed using large arrays of sealed drift-tubes, arranged in orthogonal layers, to form detector arrays that enable three-dimensional tracking of muons and electrons. These sealed tube detector arrays 301 and 303 are arranged above and below the volume of interest respectively and used to track each charged particle as it enters and leaves the scanner. Changes in the trajectory of the particle are analyzed to produce a three-dimensional representation of the materials in the volume. When the particle is attenuated in the volume, the absence of an outgoing trajectory is recognized and analyzed for the attenuation image.

FIG. 3B is a schematic shown an exemplary detector assembly 300 for detecting cosmic ray charged particles traversing a volume of interest (VOI). As briefly described above with respect to FIG. 3A, the scanner 300 is strategically arranged around a VOI 210 (e.g., top and bottom of the VOI) to detect and track cosmic ray charged particles traversing through the VOI 210. The scanner 300 includes multiple drift tube arranged to form detector arrays 301 and 303 designed to allow investigation of the scanned VOI 210. A drift tube 302 is a sealed ionization chamber with a coaxial transmission line filled with a mixture of low-pressure gases. The sealed ionization chamber of a drift tube 302 can be implemented as a hollow cylinder (e.g., 2 inch-diameter aluminum tubes) that is filled with gas and sealed. The aluminum wall of the drift tube acts as a cathode 304. A fine gold plated tungsten-rhenium wire element is strung down the long axis of the tube to act as an anode 306. The drift tube 302 produces electrical signals in response to ionization radiation that passes into or through its volume. The drift tube 302 combines three functions into a single device: sensing, timing and gain.

The gas in the drift tube is ionized by incidence of muons that creates electron-ion pairs. For gamma rays, electrons are produced when the gamma ray is incident on the aluminum shell of the drift tube that then ionizes the gas in the drift tube. Since a high-potential difference is maintained between the anode and the cathode (nominally 2.9 kV), the electrons thus created drift towards the anode and collide with other molecules along the way, with the positively charged ions moving towards the cathode. The electrons then reach the anode, producing a measureable current in the anode wire. The time that elapses between the muon incidence on the drift tube and the measured signal in the anode wire is known as the drift time. The further the muon trajectory is from the anode, the longer the drift time. The gas itself includes a mixture of helium (4He), ethane, tetrafluoromethane, and argon, chosen to ensure performance and to sustain the large electrical fields inside the drift tube without breakdown. Other gas compositions may be used instead such as, for example, a mixture of argon, nitrogen, and carbon dioxide.

In order to inspect a large volume, the drift tubes 302 in the scanner 300 are arranged to operate as pairs with each pair representing a channel. For an exemplary detector array having 17,280 individual drift tubes, there are 8,640 separate signal channels. The pairs of drift tubes and corresponding signal channels can be organized hierarchically into a composite unit called a module 340, 350, 360, 370, 380 and 390. The exemplary detector array having 17,280 drift tubes and 8,640 corresponding signal channels can be organized hierarchically into 360 modules of 24 channels each. In addition, the modules can be organized into groups of Super Modules (SM). For the exemplary detector array having 360 modules, four SMs 320, 322, 324 and 326 can be formed with each SM including 90 modules. The exemplary detector array can then be arranged to have two SMs 320 and 322 arrayed end-to-end above the VOI 210 to form the upper detector array 301, and two SMs 324 and 326 arrayed end-to-end below the VOI 210 to form the lower detector array 303. Cosmic ray charged particles penetrate the atmosphere from above and descend, entering the VOI 310 through the upper SMs 320 and 322 and either exiting through the lower SMs 324 and 326 or are absorbed inside the VOI 310.

On the bottom of FIG. 3B is an exploded view of SM 324 showing a collection of modules arrayed in six layers 340, 350, 360, 370, 380 and 390, alternating between X-facing (e.g., 24-ft) and Y-facing (e.g., 36-ft) modules. While the exploded view is shown for one SM 324, each of the SMs can be arranged in substantially similar manner. As described above and shown in FIG. 3B, the SMs 320, 322, 324 and 326 are arranged to have one SM (or two SM arrayed end to end) suspended above the VOI 310 and one SM (or two SM arrayed end to end) suspended below the VOI 310 to track cosmic ray charged particles that pass through the VOI 310.

Because the incoming cosmic ray charged particles are random in nature (rather than a directed, well-characterized beam as in conventional, active-source tomography systems), aspects of the particle detection including accurate location and timing of the particle trajectories are particularly critical to successful implementation of the tomographic imaging system. Signals coming from multiple detector arrays are time synchronized to a common system clock in order to record the signals from the multiple detector arrays against a common time base. The disclosed technology can potentially enable tracking and recreation of trajectories of individual cosmic ray-based particles entering the VOI even when the particles are (a) arriving at unknown times and traveling in unknown directions, (b) being scattered by unknown amounts as the particles traverse the VOI, or (c) being absorbed inside the VOI. To track and create the trajectories of individual particles in above described conditions, the disclosed technology can be used to (a) condition each detector array stably to obtain a reliable timing of detection pulses and (b) synchronize the timing across a large array of detectors (e.g., thousands of drift tubes) with very high accuracy (e.g., to within 20 ns). Subsequent electronics can process the digitized data to reconstruct the density distribution in the VOI.

Imaging and Detection Software and Algorithms

In the MMPDS scanner, cosmic ray muons and electrons are tracked into and out of a volume of interest. Their collective scattering information is used to reconstruct the materials through which the muon and electrons have passed. Each scattered particle provides a measurement of the scattering angle and an approximate location of the scattering. These data are used to reconstruct a three-dimensional map of the proton and electron densities of the interrogated materials. After tomographic reconstruction from particle scattering and momentum data, threat objects may be identified and distinguished from benign cargo on the basis of their size, shape, atomic number and density. For SNM and other high-Z, high density nuclear threats, muons are the primary probe, whereas for lower density contraband, including explosives and narcotics, a combination of muon and electron dynamics is most effective in detection and discrimination of the materials.

Charged Particle Imaging

Image reconstruction of the scan volume can be performed by determining the incoming and outgoing tracks of the muons and electrons as they pass through the upper detector array, the scanned volume and the lower detector array. The incoming and outgoing tracks of muons and electrons are determined using the locations on the drift tubes at which the muons and electrons were incident. As stated above, this positional information can be derived from the temporal information of the electrical signal in the output of the drift tube.

Multiple Coulomb Scattering Imaging

The scan volume between the detector arrays (e.g., between upper and lower detector arrays) is divided into voxels. Once the incoming and outgoing tracks of muons and electrons are determined, the scattering angle θ and the scattering location and its corresponding voxel are estimated. This estimation varies based on the reconstruction algorithm used. A distribution is accumulated for each voxel. As more muons and electrons enter and scatter in the scan volume, the voxel scattering strength distribution is updated. The scattering density map is calculated at the end of a scan period using a statistic characterizing the mean square scattering of the distribution of scattering per unit depth within each voxel. Iterations of this process produce better estimates of the portion of scattering caused by each voxel and therefore higher fidelity estimation of the scattering density along the path of the charged particle.

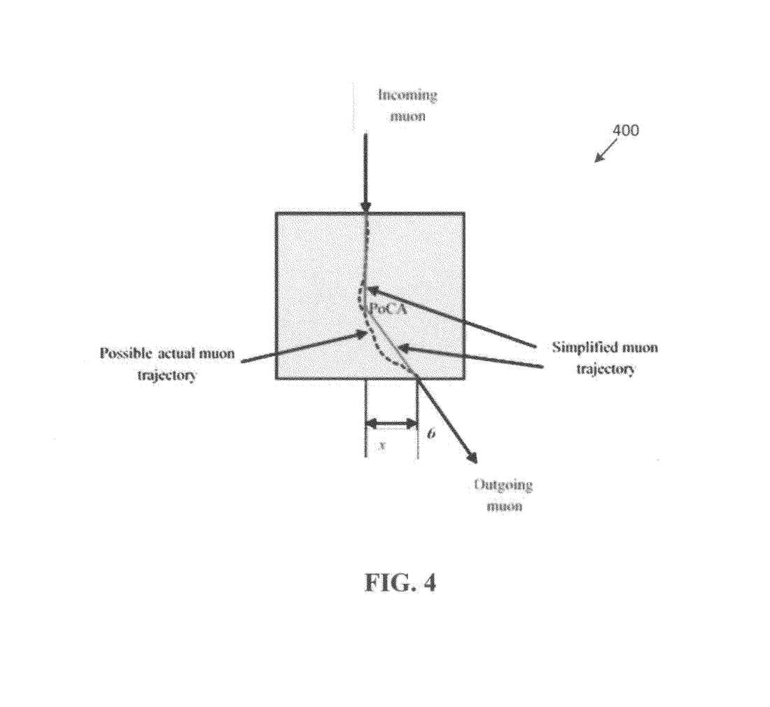

FIG. 4 is a schematic diagram 400 of the scattering of a cosmic ray particle in an object. The actual particle trajectory inside the object is not known, but the incoming and outgoing trajectory of the particle can be measured. The scattering angle is the angle θ between the incoming and outgoing particle trajectories. In a simplified model, the scattering location is considered to be in the region where the extrapolated incoming and outgoing trajectories are closest to each other. The trajectories may not necessarily intersect as shown in the figure. This location of closest approach is called the ‘point of closest approach’ or ‘PoCA’.

Charged Particle Attenuation Imaging

In addition to the scattering information, the attenuation of the muons and electrons is used to help reconstruct the scan volume. The attenuation of the particles inside the scan volume results in a particle track being detected at the upper detector array without a corresponding particle track being detected at the lower detector array. The momentum loss density map is calculated at the end of a scan period using a statistic characterizing the mean momentum loss per unit depth within each voxel. Iterations of this process produce better estimates of the portion of energy loss caused by each traversed voxel, therefore producing higher fidelity estimation of the momentum loss along the path of the charged particle.

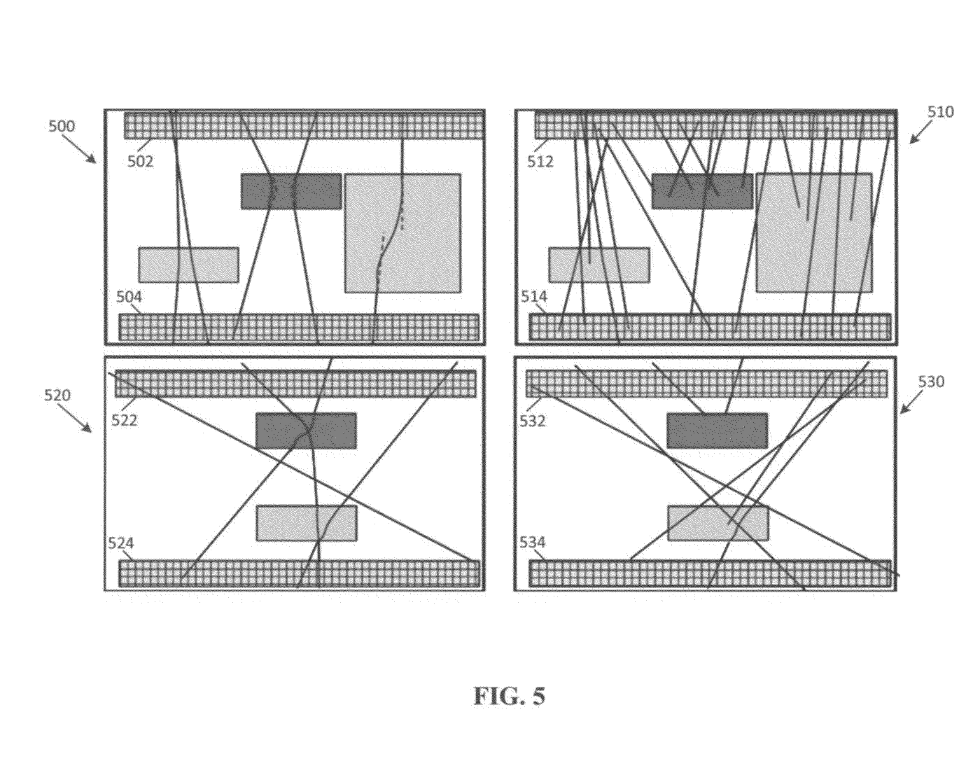

FIG. 5 is a schematic diagram of scattering and stopping of tracks passing through objects in four different scan volume examples 500, 510, 520 and 530 between the upper detector array (502, 512, 522, 532) and lower detector array (504, 514, 524, 534). The scattering angle reflects the integrated proton density through which the particle passes. The scattering point provides information as to the vertical location of the scattering source. The distance of closest approach between the reconstructed trajectories provides information related to the physical thickness of the material traversed. Attenuated particles provide information related to the integrated stopping power of the material through which they pass. For both techniques, multiple angle exploration of the volume by charged particles helps to resolve remaining ambiguity as to the position of materials in the volume.

Gamma Detection and Localization

Smuggling of nuclear material is very likely to involve an attempt at hiding the gamma emissions of the nuclear material using a high-density shielding material. Shielded packages containing nuclear and radioactive materials can be imaged from their scattering and absorption characteristics of charged particles. If the material is transported in an unshielded configuration, gamma emissions allow the detection and location of nuclear or radiological materials. As stated above, the sealed drift tubes detect gamma radiation in addition to cosmic-ray charged particles. While individual sealed drift tube sensitivities to incident gamma radiation are low, the large field of regard for the assembled detector arrays of sealed drift tubes results in a highly sensitive passive gamma detector. The detector arrays are arranged layers of sealed drift tubes, providing greater than 30% efficiency for detection of a gamma ray incident on the detector array. In order to accurately determine the presence of a gamma source in the scan volume, the background level of gamma radiation needs to be measured and accounted for. Since this background level can change during the day, the background needs to be monitored periodically. This is accommodated in the MMPDS through an automated calibration process. Additional corrections can be made for attenuation of background gamma rates in the object under inspection. The presence of multiple sensors at known locations enables generation of a spatial map of the radiation intensity which enables the source to be spatially localized and facilitates differentiation of NORM from threats (which tend to be point sources).

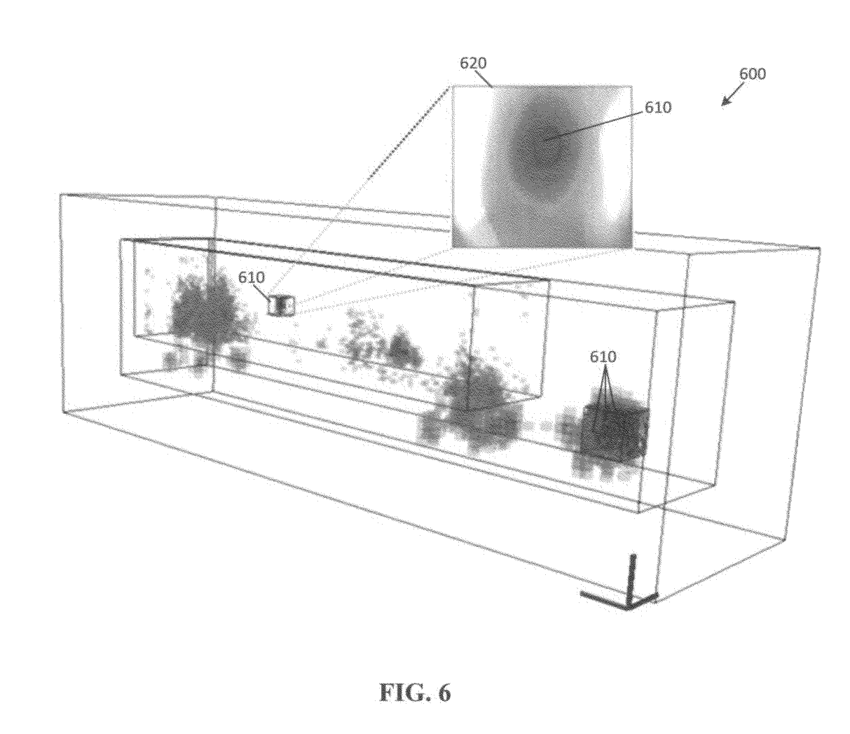

FIG. 6 is a reconstructed map 600 of the scan volume showing high scattering regions in red 610. A threat has been detected and located and the corresponding region 620 has been magnified and shown.

Nuclear and Radiological Material Detection

The MMPDS can be implemented in a fixed portal configuration that integrates cosmic-ray (electron and muon) scanning with passive gamma detection. These stationary scanners can employ at least two detector arrays (one detector array above and another detector array below the scanned volume) to track incoming or outgoing muons and electrons and sense gamma emissions. The conveyance is moved into the scan volume and scanning commences once it is stationary. Charged particle imaging and gamma detection are performed concurrently during data acquisition. At periodic exposure times, the gamma emission signal and material map are evaluated for the presence of threat materials. When no significant gamma emissions are detected, the material map is searched for thicknesses of shielding that could be blocking these gamma emissions from a specified minimum SNM mass or radiological material strength. When no such shielding is found, the conveyance is cleared, with a target scan time of less than 60 seconds. In the case where gamma emissions are measured, the material map is searched for the specified minimum SNM mass. The gamma location information can be used to guide this search. When no such mass is found, and the gamma levels are determined to be below an established threat level, the conveyance is cleared. In the case where sufficient shielding is identified in the material map, extended scanning is employed to confirm or refute the presence of SNM within the identified shielding region. When no such mass is found within the shielding, the conveyance can be cleared. When the presence of high-Z SNM is confirmed, the conveyance is referred to the appropriate response authorities. MMPDS performs this analysis automatically for primary scanning, providing the operator with either a go (clear) or no-go (suspicious) indication.

Detection of Contraband

MMPDS can be implemented to automatically detect bulk contraband such as drugs and explosives as well as highlight suspicious configurations of materials in a cargo container or crates. Several materials, including both threats and confounding materials (materials with signatures similar to threat materials) have been scanned. From this data, a preliminary library has been populated with both threat and benign materials. Scans of these materials in a clutter-free environment have demonstrated the capability to automatically detect and identify the materials of interest. Current development is focused on expanding the library of materials and enhancing performance for complex clutter situations.

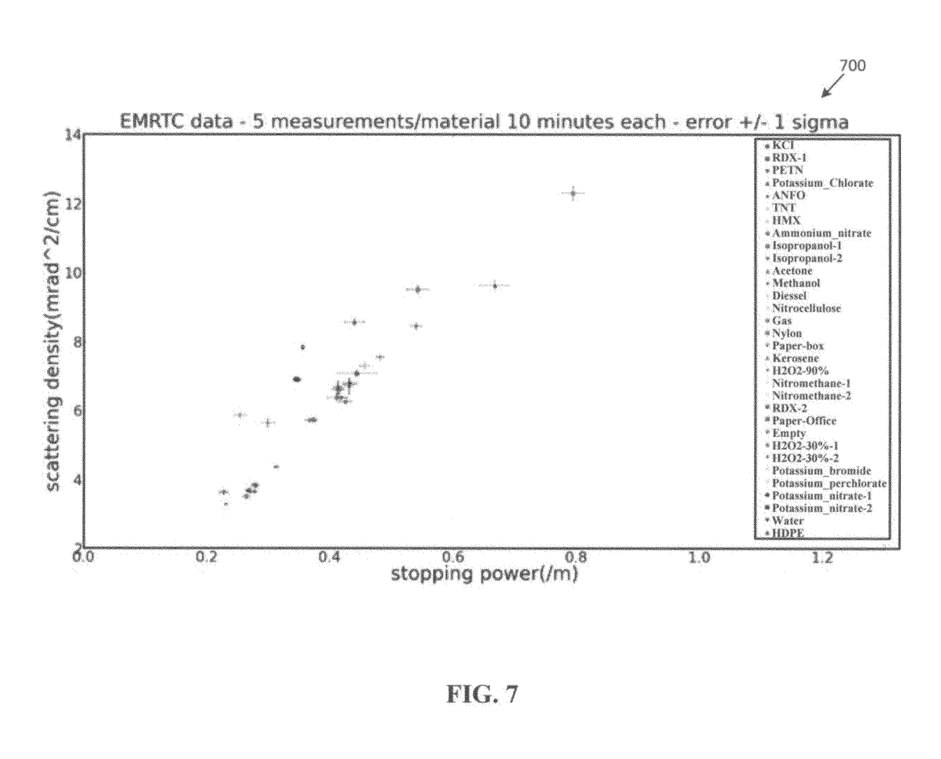

FIG. 7 is a plot 700 showing material discrimination based on measured cosmic ray parameters of scattering density and stopping power based on a ten minute scan of a number of materials including explosives, flammables, and explosive precursors. The one-standard deviation error bars are also shown. The parameters are measured from the image of the volume and can be used to differentiate and identify materials. The plot shows a number of lower density materials. Metals and other higher density materials can also be differentiated with their parameters having a significantly larger value than the lower density materials that are shown on the plot.

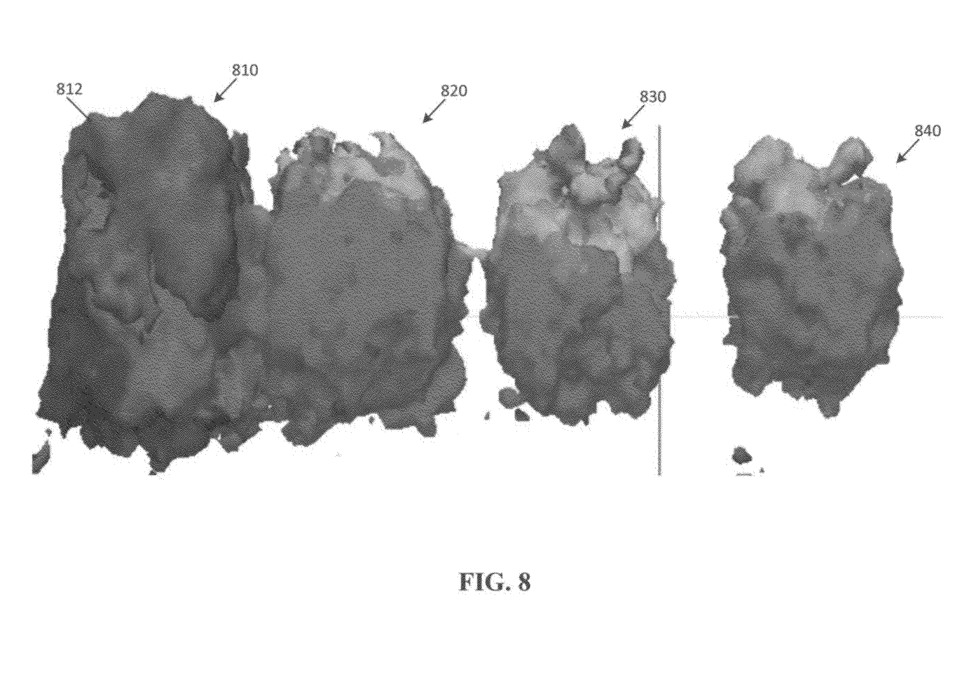

FIG. 8 shows cosmic-ray scan image (3 minute exposure) of four pallets 810, 820, 830, and 840 of office paper with glossy paper replacing the top layer on the left-most pallet 810. Paper coloring is based on the uncorrected scattering signal. The volume segmented and identified as glossy magazines is false-colored red 812 according to its signature match.

Port Scanning Operational Flexibility

The MMPDS can be implemented in various configurations based on the scan location, scan application, or both. For example, the MMPDS can be configured as a tractor-trailer MMPDS design for scanning containers loaded on tractor-trailers. The tractor-trailer MMPDS configuration can be installed at existing interchange islands and scanning can be performed concurrent with other activities. Other configurations may be more appropriate for performing on-pier scanning at a port for transshipped containers. For example, a relocatable MMPDS configuration can be implemented to handle and scan the containers delivered and retrieved by cranes or straddle carriers. Such a relocatable scan system can be scaled according to throughput and port operational concept to provide cost effective architecture for both high and low volume scanning

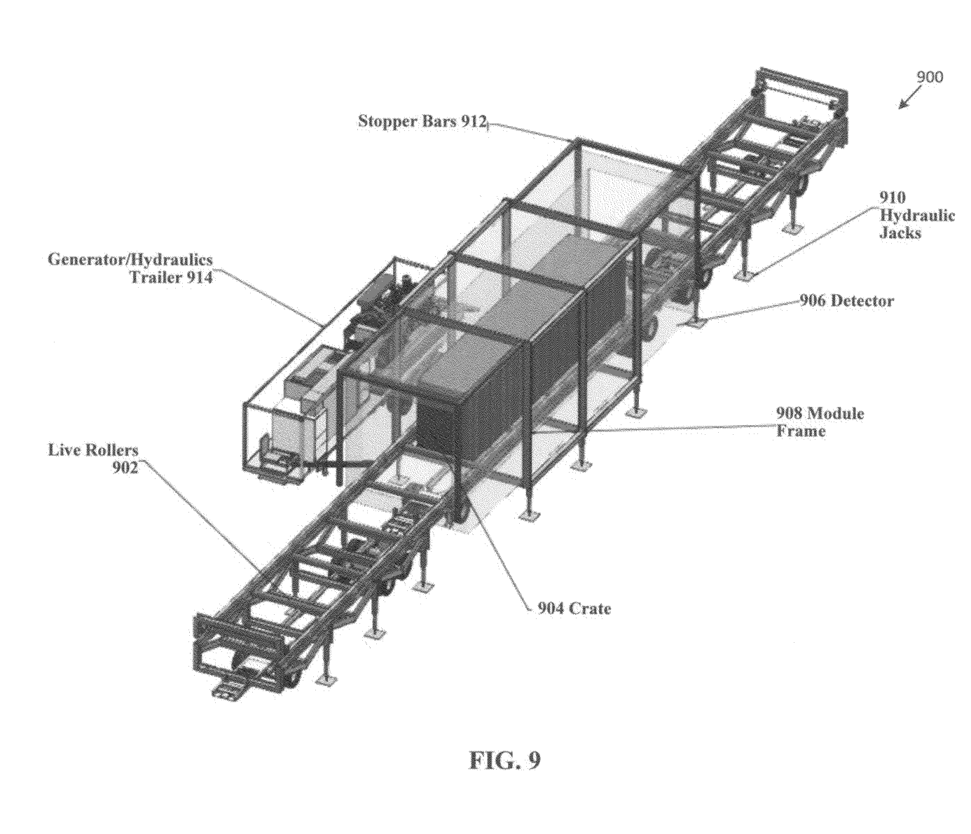

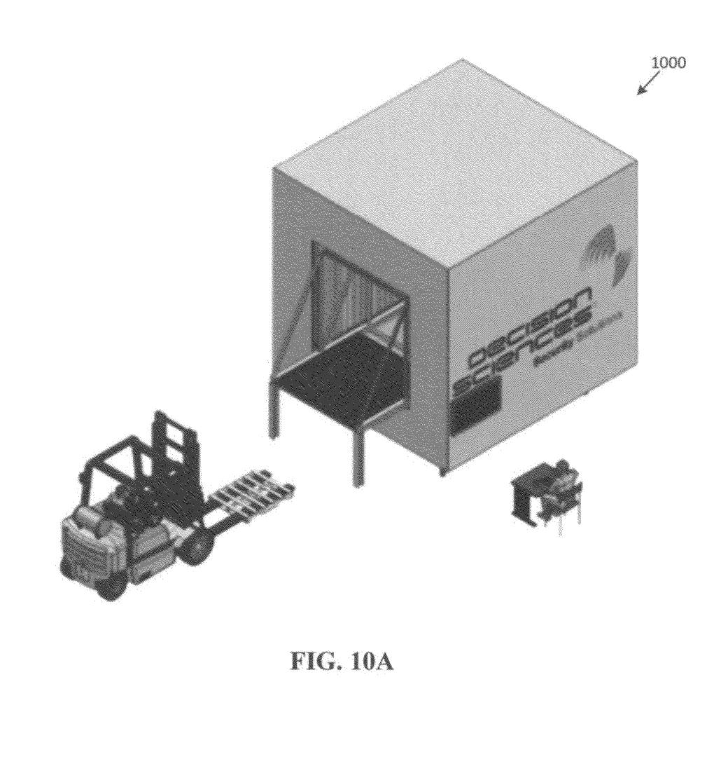

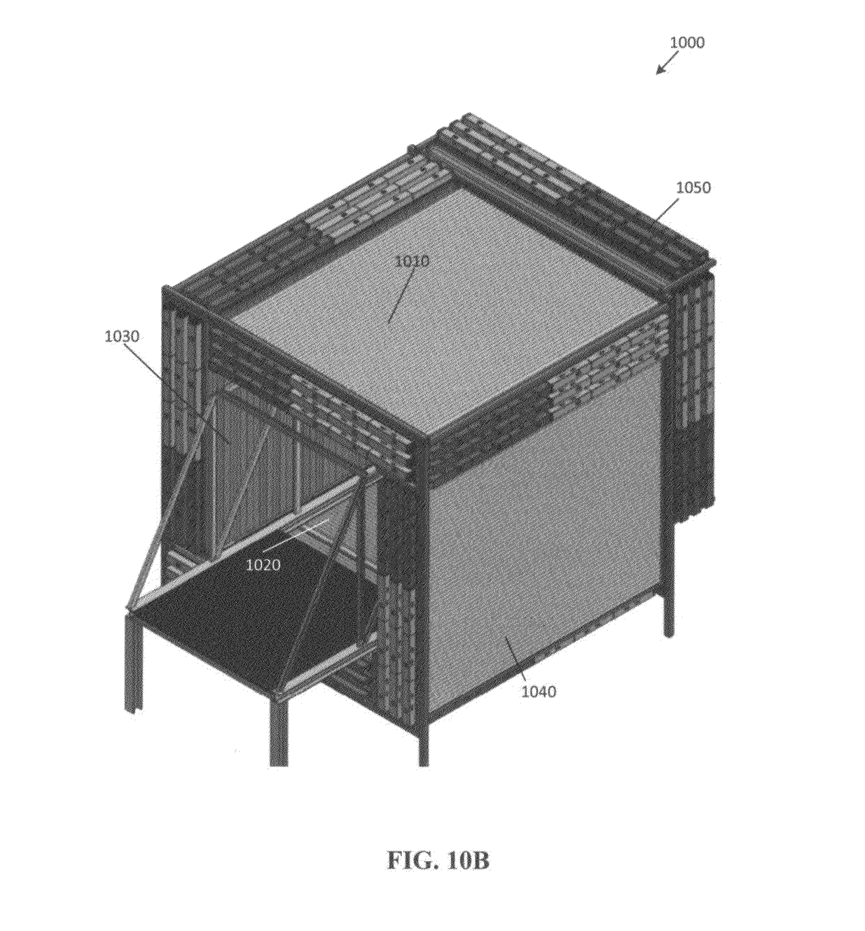

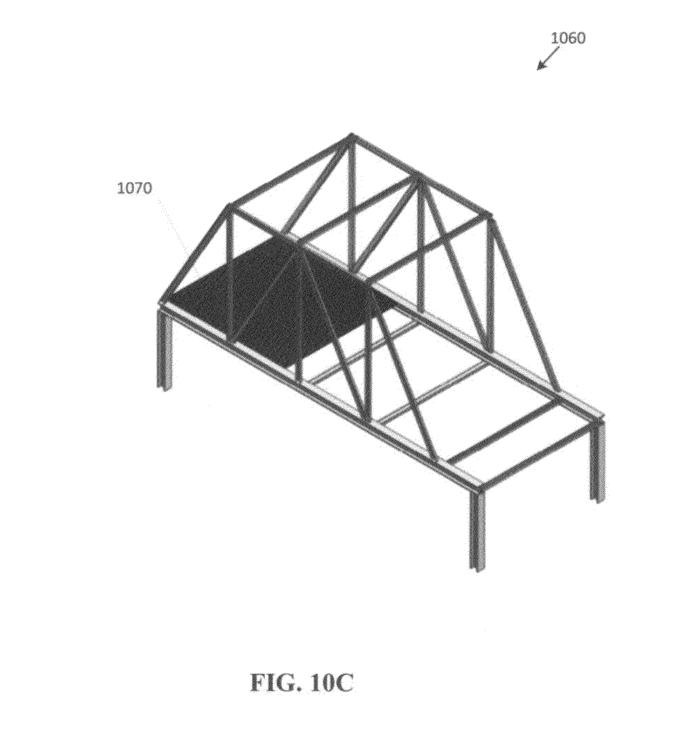

Also, the MMPDS can be scaled to accommodate air cargo scanning or pallet scanning in-line with aircraft loading or at a warehouse or storage location as shown in FIG. 9 and FIG. 10, for example.

FIG. 9 is a drawing showing an exemplary container-handling configuration design 900 for implementing MMPDS. The container-handling configuration shown in FIG. 9 can better accommodate on-pier scanning at a port for transshipped containers, for example. A smaller version of the container-handling configuration can also accommodate scanning of air-cargo containers or crates in line with aircraft loading. The container-handling configuration 900 can include a platform structure 900 for receiving and loading large containers to be scanned. The platform structure can be disposed over a set of wheels for transporting the MMPDS-based scanner. The platform structure can be supported by independently adjustable hydraulic jacks or other appropriate base to stabilize the MMPDS-based scanner when in operation mode to scan objects such as cargo containers or crates. The independently adjustable hydraulic jacks allow the container-handling configuration of the MMPDS-based scanner to be stable independent of the shape of the terrain on which the container-handling configuration of the MMPDS-based scanner is positioned.

The platform can include live rollers 902 for moving the cargo container or crates from one end (the input side) to the other end (the output side) to position the cargo container or crates 904 within a scan volume area. At a predetermined location between the two ends of the platform, the MMPDS-based scanner is positioned to provide the scan volume area along a path of the cargo container or crates 904 moving from one end (the input side) of the platform to the other end (output) of the platform. The rollers 902 allow the heavy cargo container or crates 904 to be positioned within the scan volume area for scanning the cargo container or crates.

The scan volume area is provided by placing at least some of the detection hardware and the support structure of the MMPDS scanner to surround a portion of the platform in an outer ring-like or outer shell-like manner. For example, the support structure for the detection hardware can include a module frame 908 positioned to surround or encompass the portion of the platform 900 and house the at least a portion of the detection hardware. As shown in FIG. 9, the module frame 908 can be structured to form a rectangular-like shape. The module frame 908 can house the detector arrays 906 of charge particle sensors, such as sealed drift tubes for detecting the incident and exiting cosmic-ray particles traversing the scan volume and for sensing gamma rays. An upper detector array can be housed in or at the top surface area of the module frame 908 located above the scan volume. A lower detector array can be housed in or at the bottom surface area of the module frame 908 located below the scan volume. The set of upper and lower detector arrays can detect the incident and exiting cosmic-ray particles traversing the scan volume from above the scan volume and for sensing gamma rays emitted by an object inside the scan volume through the top and bottom. Additional detector arrays, such as side or lateral array detectors can also be housed at or in the two lateral sides of the module frame 908 to provide a box-like detector array configuration for detecting cosmic-ray particles incident and exiting cosmic-ray particles traversing the scan volume laterally and to sense gamma rays emitted by an object inside the scan volume through the sides of the scan volume. The module frame 908 can be supported by hydraulic jacks 910 or other appropriate base to stabilize the module frame 908 in a manner similar to the platform 900.

In addition, the container-handling configuration 900 can include stopper bars 912 or similar structures to protect the detector arrays from cargo containers or crates 904 while the cargo containers or crates 904 are within the scan volume area or entering and exiting the scan volume area. Inadvertent terrain movement or structural sway of the platform, module frame 908, or the crane loading and unloading the cargo containers or crates 904 could physically damage the detector arrays, and the stopper bars 912 can provide a physical barrier protection against such damages.

A generator/hydraulics 914 can be housed in a separate building, such as a trailer to provide power and control for the container-handling configuration platform 900. The generator/hydraulics 914 can provide power and communicate control signals for the scan operation of the MMPDS-based scanner and the platform to move, position and scan the cargo containers or crates 904.

FIG. 10A is a drawing showing a pallet and large package configuration design. The pallet and large package configuration can better accommodate warehouse or loading-dock scanning of cargo. The components of the pallet and large package configuration 1000 in FIG. 10A can be substantially similar to the container-handling configuration platform 900 in FIG. 9 with some variations. For example, pallet and large package configuration 1000 can include a platform similar to the one in the container-handling configuration 900 that includes rollers for moving pallets and large packages loaded onto one end (e.g., input) of the platform to be positioned within a scan volume area to be scanned. The scan volume area is positioned at a predetermined location along a path of the platform. The scan volume area is provided by positioning a support structure that houses detector arrays, such as the one shown in FIG. 10B. The support structure can be built to house at least part of the detector hardware for the MMPDS-based scanner including a pair of upper and lower detector array above and below the scan volume to detect incident and exiting cosmic-ray particles traversing the scan volume from above the scan volume. The support structure can also house a pair of laterally positioned detector arrays at opposing sides of the support structure to detect incident and exiting cosmic ray particles entering through the sides of the scan volume. The detector arrays can also sense gamma radiation emitting from an object within the scan volume.

In addition, the pallet and large package configuration 1000 is sized to provide the scan volume area appropriate to contain pallets and large packages expected to be present at warehouses or loading-docks. The pallet and large package configuration 1000 can include all or part of the detector hardware including power source housed in the support structure or have the detector hardware, power source, or both external to the support structure. An operator can control operation of the platform and the MMPDS-based scanner from a remote location external to the support structure wirelessly or via hardwire.

FIG. 10B is a diagram showing a view of an exemplary MMPDS Scanner in a pallet and large package configuration 1000 with external enclosure removed, exposing drift-tube sensor panels and the detector support frame. In the example shown in FIG. 10B, the MMPDS scanner includes an upper detector array 1010 disposed above a scan volume, a lower detector array 1020 disposed below the scan volume, and additional lateral detector arrays 1030 and 1040 disposed on or in the side walls of the pallet and large package configuration 1000 surrounding the scan volume.

As described above, the hardware components for the pallet and large package configuration 1000 can include thousands of sealed drift tubes that are assembled into groups or modules that are then assembled into clusters of modules called super-modules. These Super-Modules are installed onsite, onto a metal detector array frame 1050 that is specifically designed to support the arrays. For the example shown in FIGS. 10A and 10B, the detector array frame should be bolted to a concrete floor with a minimum thickness of 5 inches and a minimum concrete rating of 3000 psi.

FIG. 10C is a drawing showing an exemplary scene support bridge and conveyor structure associated with the pallet and large package configuration 1000. The scene support bridge and conveyor structure 1060 includes an actuated conveyor assembly for loading of cargo and insertion into the scan region or scan volume. A plate 1070 can be provided as a part of the actuated conveyor assembly that slides in and out of the scan volume or scan region with a cargo, such as a pallet on top of the plate 1070. In the example shown in FIG. 10C, the scene support bridge and conveyor structure 1060 can load up to 2000 lbs. and can be placed on the rigid platform, such as the plate 1060 which is then moved into the scan region via a mechanical, screw-drive actuation system.

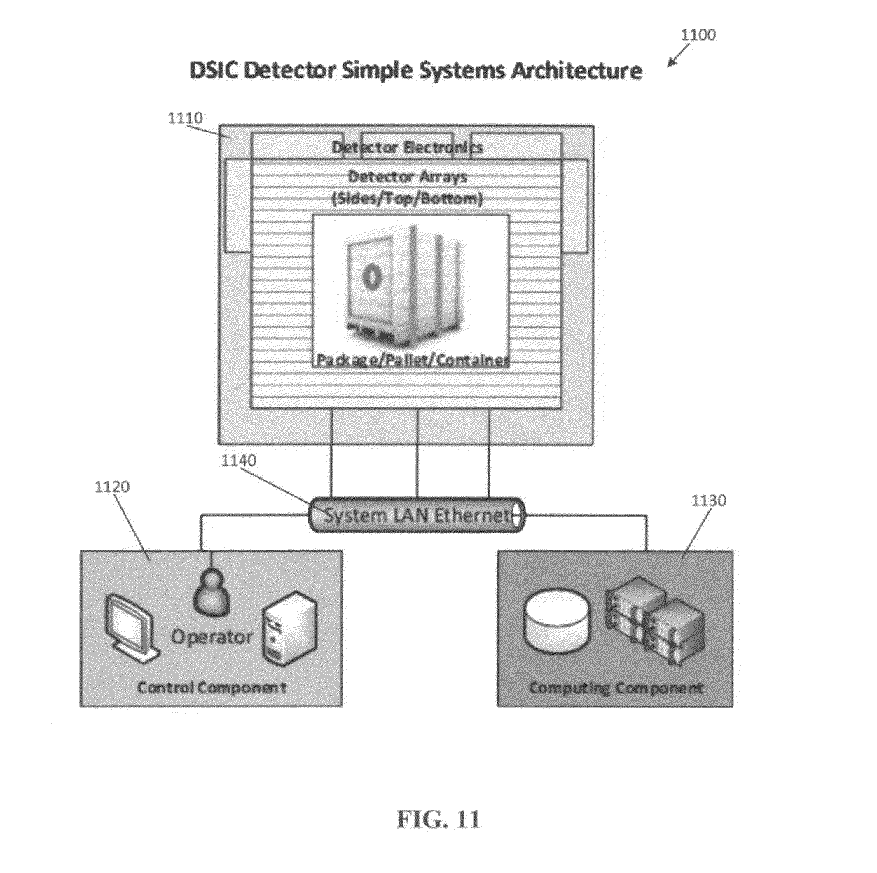

FIG. 11 is a data flow diagram showing an exemplary systems 1100 architecture for implementing a pallet and large package configuration 1000 using MMPDS. The exemplary system 1100 can be a static system installed at a desired location and can include three component groups: Hardware (Detector arrays and Electronics) 1110, Control (User interface) 1120 and Computing (Software, Servers & Data Storage) 1130. The Hardware group 1110 that includes the detector arrays and the corresponding custom electronics can be integrated with the system structure, which includes the metal detector array frame 1050 and the scene support bridge and conveyor structure 1060. The Control and Computing Component groups 1120 and 1130 respectively can be connected to the Hardware Component group 1110 via Ethernet 1140, permitting local or remote control and operation, for example. The computing component 1130 can communicate with existing Customs systems and databases if integration is desired or requested. These component groups 1110, 1120, 1130, when integrated, can make up the complete system.

The system 1100 can be designed for indoor operation. The system 1110 can be operated in temperatures ranging from 0° C.-40° C., for example. A minimum of 20 kilowatts of single phase AC power can be used to operate the hardware component, including its internal environmental control system. CAT-6 Ethernet cable is run from the Detector Hardware to the other components of the system.

The Computing Component 1130 can contain all the application servers, database servers, data storage and network equipment used to carry out software. The computing component 1130 for the pallet scanner configuration 1000 can reside in a 36U sized computer rack, for example. The computing component 1130 can be operated in a climate controlled environment between 15 C and 25 C. A minimum of 5 kilowatts of single-phase AC power can be used with an additional 2 kilowatts if an environmental enclosure is used. Access to external networks can be supplied to the computing component.

The Control Component 1120 includes a display computer and operator terminal. This can be housed next to the system 1100 or in a separate area provided the necessary communication links are provided. The Control Component can contain all of the equipment necessary to control the system and to conduct visual image analysis via high-resolution monitors and, like the Data Center, can also contain the entire infrastructure necessary to carry out operations.

The display computer is a standard PC, so it could potentially be integrated with existing Customs displays in existing centers. The machine is capable of performing complex rendering and image display tasks.

The system 1100 can be installed in an enclosed area protected from weather including rain, extreme heat and cold, and dust. This facility should be supported by infrastructure elements such as power and communications. The area should be in a temperature range of 10° C. to 40° C.

The MMPDS-based pallet scanner in the system 1100 uses specific configuration of electrical power, telecommunications (e.g., IT related such as Local Area Networks (LAN)/Wide Area Networks (WAN)), and environment conditioning systems such as air conditioners, uninterruptible power supply (UPS), generators, and power cleaners. The specifications for type and configuration of each element can be dependent upon customer requirements, location, and the solution proposed.

Other Nuclear Security and Safety Applications for Cosmic Ray Scanning

Properties of cosmic ray-charged particle scanning including the high signal from nuclear materials relative to common materials, the penetration of very heavy clutter and shielding and absence of added radiation, make it a viable candidate for many scanning and monitoring operations in the nuclear industry. For example, muon scanning can be used to scan or monitor fuel rods within storage vessels. Muons can also be used to scan nuclear reactor cores to confirm the presence of the fuel as well as determine its configuration in the case of a meltdown or other incident.

While this document contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Only a few implementations and examples are described and other implementations, enhancements and variations can be made based on what is described and illustrated in this document.

What is claimed is:

1. A relocatable multimode passive detection system, comprising:
a platform structure sized to receive cargo containers to be scanned;
a support base to provide physical support for the platform, wherein the support base includes adjustable members to compensate for a variation in terrain on which the support base in placed;
multimode passive detection-based scanner hardware including detector arrays of charge particle sensors; and
a scanner housing to house at least some of the hardware for the multimode passive detection-based scanner, wherein the scanner housing is located at a predetermined location between two ends of the platform structure to provide a scan volume sized to hold a cargo container to be scanned.

2. The relocatable multimode passive detection system of claim 1, wherein the detector arrays include an upper detector array placed above the scan volume and a lower detector array placed below the scan volume to detect cosmic-ray particles entering and exiting the scan volume from above the scan volume.

3. The relocatable multimode passive detection system of claim 1, wherein the detector arrays include one or more lateral detector arrays placed at sides of the scan volume to detect cosmic-ray particles entering or exiting the scan volume through the sides of the scan volume.

4. The relocatable multimode passive detection system of claim 3, wherein the detector arrays include up to three lateral detector arrays placed at the sides of the scan volume to detect cosmic-ray particles entering or exiting the scan volume through the sides of the scan volume.

5. The relocatable multimode passive detection system of claim 1, wherein the support base includes a set of wheels for relocating the multimode passive detection system.

6. The relocatable multimode passive detection system of claim 1, wherein the adjustable members include adjustable support columns.

7. The relocatable multimode passive detection system of claim 6, wherein the adjustable support columns include hydraulic or screw jacks.

8. The relocatable multimode passive detection system of claim 1, wherein components of the relocatable multimode passive detection system are structured and sized to accommodate on-pier scanning at a port for scanning cargo containers.

9. The relocatable multimode passive detection system of claim 1, wherein components of the relocatable multimode passive detection system are structured and sized to accommodate scanning of air-cargo containers or crates in line with aircraft loading.

10. The relocatable multimode passive detection system of claim 1, wherein the platform structure includes rollers for moving the cargo container from one end to other end.

11. The relocatable multimode passive detection system of claim 1, wherein the scan volume area is provided by placing the scanner housing and at least some of the hardware to surround a portion of the platform in an outer ring-like or outer shell-like manner.

12. The relocatable multimode passive detection system of claim 11, wherein the scanner housing can include a module frame positioned to surround or encompass a portion of the platform structure to form a rectangular-like shape.

13. The relocatable multimode passive detection system of claim 1, wherein charge particle sensors include sealed drift tubes.

14. The relocatable multimode passive detection system of claim 13, wherein the charge particle sensors are structured to sense gamma rays.

15. The relocatable multimode passive detection system of claim 1, including stopper bars to protect the hardware from physical damage.

16. A relocatable multimode passive detection system, comprising:
a platform structure sized to receive pallets or large packages to be scanned;
a support base to provide physical support for the platform, wherein the support base includes adjustable members to compensate for a variation in terrain on which the support base in placed;
multimode passive detection-based scanner hardware including detector arrays of charge particle sensors; and
a scanner housing to house at least some of the hardware for the multimode passive detection-based scanner, wherein the scanner housing is locating at a predetermined location between two ends of the platform structure to provide a scan volume sized to hold a cargo container to be scanned.

17. The relocatable multimode passive detection system of claim 16, wherein the detector arrays include an upper detector array placed above the scan volume and a lower detector array placed below the scan volume to detect cosmic-ray particles entering and exiting the scan volume from above the scan volume.

18. The relocatable multimode passive detection system of claim 16, wherein the detector arrays include a pair of lateral detector arrays placed at two opposing sides of the scan volume to detect cosmic-ray particles entering and exiting the scan volume from either side of the scan volume.

19. The relocatable multimode passive detection system of claim 16, wherein components of the relocatable multimode passive detection system are structured and sized to accommodate scanning of the pallets or large containers at a warehouse.

20. The relocatable multimode passive detection system of claim 16, wherein components of the relocatable multimode passive detection system are structured and sized to accommodate scanning of the pallets or large containers at a loading-dock.
